(19) United States
(12) Patent Application Publication
(10) Pub. No.: US 2012/0076265 A1
(43) Pub. Date: Mar. 29, 2012

(54) Portable radiation imaging system, holding device used therein, and portable radiation imaging apparatus

(75) Inventors: Yasunori Ohta, Kanagawa (JP); Naoyuki Nishino, Kanagawa (JP); Yusuke Kitagawa, Kanagawa (JP); Noriaki Ida, Kanagawa (JP); Tetsuro Kusunoki, Kanagawa (JP); Takeshi Kamiya, Kanagawa (JP)

(73) Assignee: FUJIFILM Corporation, Tokyo (JP)

(21) Appl. No.: 13/137,956

(22) Filed: Sep. 22, 2011

(30) Foreign Application Priority Data
Sep. 27, 2010 (JP) 2010-214940

(51) Int. Cl. G01N 23/04

(52) U.S. Cl. 378/62

(57) ABSTRACT

Each of two X-ray sources hangs from a hook movably attached to a horizontal bar of a holding device. The horizontal bar is provided with a position indicating section that indicates positions suitable for each of the X-ray sources, corresponding to an object of interest (the size of X-ray irradiation area). The position indicating section has first to third lamps arranged at the respective suitable positions. Out of the first to third lamps, a holding device controller of an imaging control device turns on lamps corresponding to the object of interest inputted from an input device of a console. The hooks are moved along rails to the positions of the lamps turned on, respectively. Movable joints of support legs are operated to adjust a distance between the X-ray sources and an image receiving surface of a cassette.

### BACKGROUND OF THE INVENTION

1. Field of the invention

The present invention relates to a portable radiation imaging system for capturing images using at least one radiation source, and a holding device and a portable radiation imaging apparatus for use in the portable radiation imaging system.

2. Description Related to the Prior Art

In diagnostic imaging using radiation, for example, X-ray, stereoscopic imaging is performed (see Japanese Patent Laid-Open Publications No. 55-132192 and No. 09-313470). To perform X-ray imaging, two X-ray sources are used. The X-ray sources are arranged at different positions from each other. Thereby, two images having parallax are obtained, allowing stereoscopic observation of an object of interest.

The Japanese Patent Laid-Open Publication No. 55-132192 discloses a basic stereoscopic imaging technique in which X-ray is applied from one or multiple X-ray sources. When the single X-ray source is used, the X-ray source is moved to at least two positions. When the multiple X-ray sources are used, the X-ray sources are arranged at their respective positions.

In the Japanese Patent Laid-Open Publication No. 09-313470, an X-ray tube using two filaments is fixed to a C arm. The two filaments form focal points for the right eye and the left eye, respectively. The C arm is moved to an appropriate position to perform the stereoscopic imaging. X-ray irradiation timing is controlled on a primary side of a step-up transformer for generating high voltage applied to the X-ray tube. Thereby, the system becomes compact, lightweight, and portable.

On the other hand, U.S. Patent Application Publication No. 2008/0240343 (corresponding to Japanese Patent Laid-Open Publication No. 2008-253762) suggests a portable X-ray imaging system suitable for use in emergency medical care at accident and disaster scenes, for example. The system is composed of an X-ray source, a holding device of the X-ray source, an X-ray detector, a power source device, a controller device, and a transportation device. The devices are transported by the transportation device and then set up on-site to perform imaging.

For the portable X-ray imaging system such as that disclosed in the U.S. Patent Application Publication No. 2008/0240343, it is important to shorten the imaging time to achieve rapidity in emergency care and simplicity in home care. Portability with less effort for assembly and imaging and lower cost compared to a non-portable full-scale system are also important factors.

In the Japanese Patent Laid-Open Publications No. 55-132192 and No. 09-313470, and the U.S. Patent Application Publication No. 2008/0240343, one or multiple X-ray sources are moved using a driving force such as a motor. However, the driving force increases the size of the system and therefore is not suitable for the portable radiation imaging system in view of portability and cost. Because the portable X-ray imaging system is used in primary care, it is not a problem to move the X-ray source manually without using the driving force.

However, in moving the X-ray source manually, caution is required, because the optimum positions for the X-ray sources vary in accordance with an X-ray irradiation area. When the stereoscopic imaging is performed using the X-ray sources arranged at incorrect positions, it becomes necessary to readjust the positions of the X-ray sources and recapture X-ray images. This prolongs the imaging time and forces a patient to be exposed to more X-ray. Even if the driving force is used, the X-ray sources cannot be arranged correctly if the driving force has a trouble, which interrupts the imaging process.

The Japanese Patent Laid-Open Publications No. 55-132192 and No. 09-313470, and the U.S. Patent Application Publication No. 2008/0240343 do not describe changing the positions of the X-ray sources in accordance with the X-ray irradiation area. As a matter of course, solutions for the problems associated with the position change are not described.

### SUMMARY OF THE INVENTION

An object of the present invention to reduce imaging time of a portable radiation imaging system while handiness thereof is improved.

In order to achieve the above and other objects, a holding device for use in a portable radiation imaging system includes a set of support legs, a support member, and a first indicating section. The set of support legs adjust a distance between at least one radiation source and an image receiving surface of a radiation image detector in accordance with a size of an irradiation area of the radiation. The radiation source applies radiation to a subject. The radiation image detector receives the radiation passed through the subject to detect an image. The support member is joined between the set of support legs. Holders, each designed to hold the radiation source, are provided in respective positions on the support member. The at least two holders are used for arranging the at least one radiation source. The radiation source applies the radiation to the subject while being held by the holder. The first indicating section is provided to the support member. The first indicating section indicates the positions of the radiation source to be arranged. The positions are distinguishable in accordance with the size of the irradiation area.

It is preferable that the support member is provided with a holder moving section for supporting the holders in a movable manner.

It is preferable that the support leg is provided with a second indicating section for indicating distance positions for adjusting the distance. The distance positions are distinguishable in accordance with the size of the irradiation area.

It is preferable that at least one of the first indicating section and the second indicating section has lamps or marks arranged at the respective positions or distance positions.

It is preferable that the holding device further includes a position detecting sensor and an alarm section. The position detecting sensor detects the position of the holder. The alarm section gives an alarm signal when a detection result of the position detecting sensor is different from the position corresponding to the size of the irradiation area.

It is preferable that the alarm section gives the alarm signal before irradiation of the radiation when the holder is not positioned at a position appropriate for applying the radiation.

It is preferable that the holding device further includes an irradiation area limiting sheet disposed between the radiation source and the radiation image detector. The irradiation area limiting sheet limits the irradiation area of the radiation applied to the subject.

It is preferable that the irradiation area limiting sheet is composed of a radiation shielding sheet, an opening, and a removable sheet. The opening is formed on the radiation shielding sheet for allowing radiation, having an amount corresponding to the irradiation area, to pass through. The removable sheet covers or uncovers the opening.

It is preferable that the holding device further includes a driving force for moving the holders to the positions corresponding to the size of the irradiation area.

A portable radiation imaging system includes at least one radiation source for applying radiation to a subject, a radiation image detector for receiving the radiation passed through the subject to detect an image, a holding device, and an image processing device for processing image data outputted from the radiation image detector. The holding device includes a set of support legs, a support member, holders, and an indicating section. The set of support legs adjust a distance between the radiation source and an image receiving surface of the radiation image detector in accordance with a size of an irradiation area of the radiation. The support member is joined between the set of support legs. The holders, each designed to hold the radiation source, are provided in respective positions on the support member. The at least two holders are used for arranging the at least one radiation source. The radiation source applies the radiation to the subject while being held by the holder. The indicating section is provided to the support member. The indicating section indicates the positions of the radiation source to be arranged. The positions are distinguishable in accordance with the size of the irradiation area.

It is preferable that the at least two image data are generated to perform stereoscopic imaging that allows stereoscopic observation.

It is preferable that the system performs tomosynthesis imaging in which at least two image data are added to obtain a tomographic image. The tomographic image emphasizes a region of interest of the subject.

It is preferable that the image processing device displays the positions corresponding to the irradiation area, out of all the positions for the radiation source, on a display.

A portable radiation imaging apparatus includes a radiation image detector for receiving radiation passed through a subject to detect an image, a holding device, and an image processing device for processing image data outputted from the radiation image detector. The holding device includes a set of support legs, a support member, holders, and an indicating section. The set of support legs adjust a distance between the at least one radiation source and an image receiving surface of the radiation image detector in accordance with a size of irradiation area of the radiation. The radiation source applies radiation to the subject. The support member is joined between the set of support legs. The holders, each designed to hold the radiation source, are provided in respective positions on the support member. The at least two holders are used for arranging the at least one radiation source. The radiation source applies the radiation to the subject while being held by the holder. The indicating section is provided to the support member. The indicating section indicates the positions of the radiation source to be arranged. The positions are distinguishable in accordance with the size of the irradiation area.

According to the present invention, the appropriate positions for the at least one radiation source are indicated in a distinguishable manner in accordance with the size of the irradiation area. The at least one radiation source is arranged at the predetermined positions correctly based on the positions indicated, eliminating imaging error. As a result, the portable radiation imaging system reduces its imaging time and improves its handiness.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a perspective view showing a schematic configuration of an X-ray imaging system;

FIG. 2 is a configuration of a horizontal bar and support legs of a holding device;

FIG. 3 is a block diagram showing an electric configuration of an imaging control device;

FIG. 4 shows a control table;

FIGS. 5A to 5C show relations between the size of an object of interest, an SID, and a distance between X-ray sources; FIG. 5A shows the relations where the object of interest is large; FIG. 5B shows the relations where the object of interest is medium-sized; FIG. 5C shows the relations where the object of interest is small;

FIGS. 6A and 6B show the X-ray imaging system covered with an X-ray shielding sheet; FIG. 6A is viewed from a body side surface of a subject; FIG. 6B is viewed from the head of the subject;

FIG. 7 is a perspective view showing a simple irradiation area limiting sheet;

FIG. 8 shows an example in which a photosensor is provided to each of rails on a horizontal bar; and

FIGS. 9A and 9B show another method for stereoscopic imaging; FIG. 9A is an example in which one of the X-ray sources is arranged at the center of the horizontal bar while the other X-ray source is shifted from the center; FIG. 9B is an example in which the X-ray sources face the cassette with the use of a swing mechanism.

### DESCRIPTION OF THE PREFERRED EMBODIMENTS

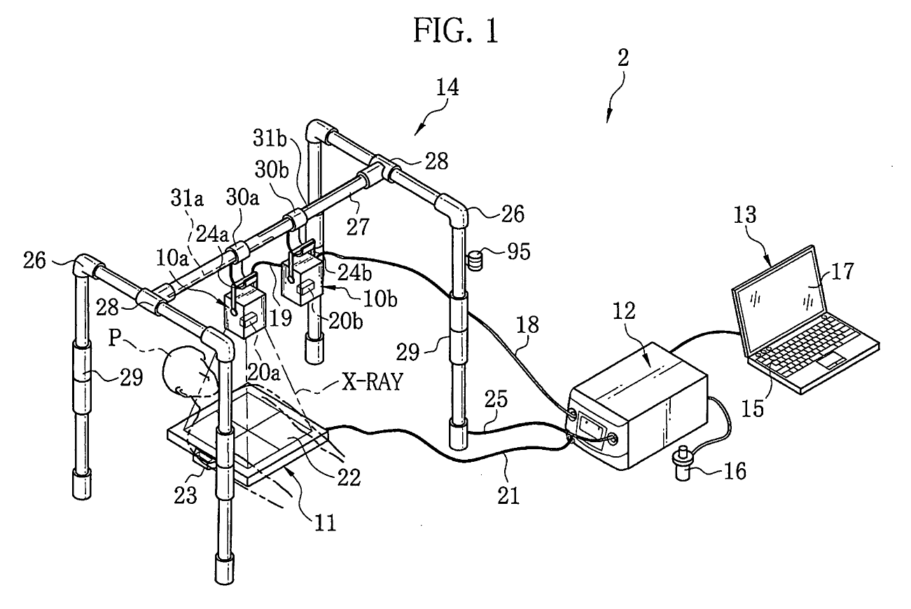

In FIG. 1, a radiation imaging system, for example, an X-ray imaging system 2 is provided with two X-ray sources 10a and 10b, a cassette 11, an imaging control device 12, a console 13, and a holding device 14. Each of the X-ray sources 10a and 10b emits X-ray. The cassette 11 detects the X-ray, emitted from the X-ray sources 10a and 10b and then passed through a subject or patient P, to output image data. The imaging control device controls imaging operations of the X-ray sources 10a and 10b and the cassette 11. The console 13 is used to set imaging conditions (tube voltage, tube current, irradiation time, and the like of an X-ray tube 20a of the X-ray source 10a and those of an X-ray tube 20b of the X-ray source 10b) to the imaging control device 12. The holding device 14 holds the X-ray sources 10a and 10b. The X-ray imaging system 2 performs stereoscopic imaging while the X-ray is applied to the subject from the X-ray sources 10a and 10b arranged at positions different from each other. Thereby, parallax images, allowing stereoscopic (3D) observation, are obtained.

Each of the X-ray sources 10a and 10b, the cassette 11, the imaging control device 12, the console 13, and the holding device 14 is portable. The X-ray imaging system 2 is transported to a site wherever emergency care or home care is necessary, for example, an accident scene or a disaster scene, or a home care patient's house to perform X-ray imaging.

Based on the imaging conditions inputted from an input device 15 of the console 13, the imaging control device 12 issues an instruction to each of the X-ray sources 10a and 10b and the cassette 11 to synchronize their respective operations. Upon receipt of a signal, instructing the X-ray irradiation, from an irradiation switch 16, the imaging control device 12 informs the cassette 11 of the receipt of the signal, and thereby the operations of the X-ray sources 10a and 10b and the cassette 11 are synchronized.

The image data outputted from the cassette 11 is inputted to the console 13 via the imaging control device 12. The console 13 is composed of a personal computer or a workstation, and performs various image processes to the image data. The console 13 displays an image on a display 17, and sends the image in an external data storage device such as an image storage server.

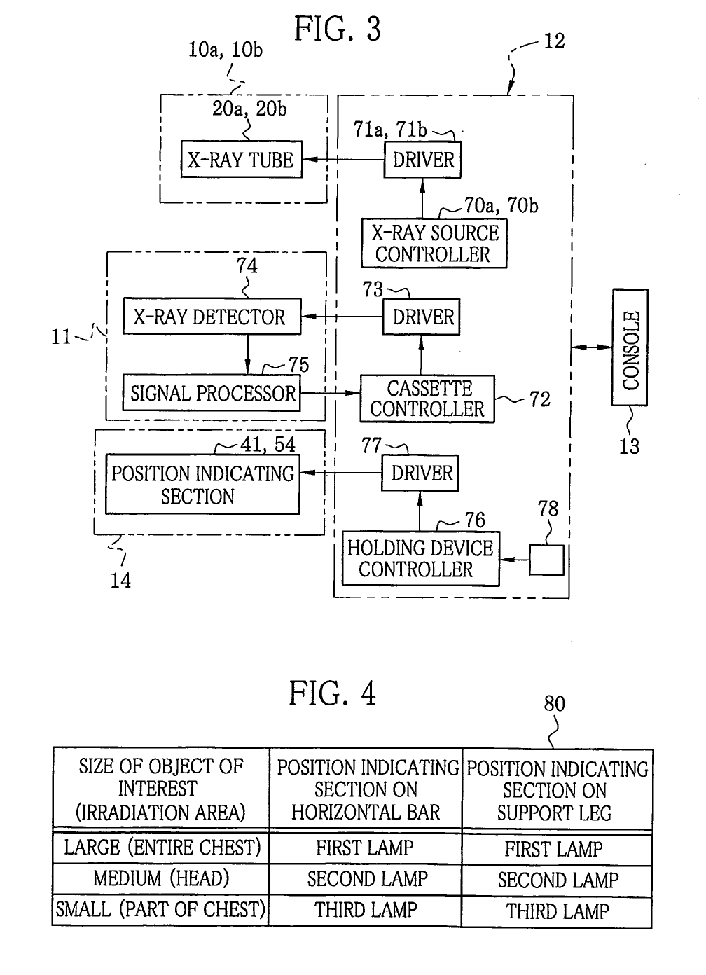

The X-ray sources 10a and 10b are connected to each other via a cable 19. The X-ray source 10b is connected to the imaging control device 12 via a cable 18. The imaging control device 12 supplies power to the X-ray sources 10a and 10b. The X-ray source 10a has the X-ray tube 20a, a collimator, and the like. The X-ray tube 20a generates the X-ray upon application of high voltage from a driver (a high voltage generator, see FIG. 3) 71a. The collimator (an X-ray field limiting device, not shown) limits an X-ray field of the X-ray generated by the X-ray tube 20a. As with the X-ray source 10a, the X-ray source 10b has the X-ray tube 20b, a collimator, and the like.

Each of the X-ray tubes 20a and 20b is a fixed anode X-ray tube with no target rotation mechanism, for example. Each of the X-ray tubes 20a and 20b uses a cold cathode electron source. In this case, unlike the hot cathode electron source, a filament and a filament heater are unnecessary. Thus, the X-ray tubes 20a and 20b are compact and lightweight. Because the filament preheating is unnecessary, the X-ray irradiation is performed immediately, responsive to the instruction of image capture. This is advantageous to the emergency care. For the X-ray tubes 20a and 20b, for example, an ultra-small X-ray generator, fitted to a coaxial cable with a diameter 2 mm or less, disclosed in Japanese Patent No. 3090910, or an X-ray tube having a carbon nano structure disclosed in “Development and Application of battery-operated ultra-small electron accelerator and high-energy X-ray source” Ryoichi SUZUKI, National Institute of Advanced Industrial Science and Technology, Mar. 29, 2009, <http://beam-physics.kek.jp/bpc/suzuki.pdf> may be used. The latter X-ray tube operates on a dry cell battery. This eliminates the use of cables between the X-ray sources 10a and 10b and the imaging control device 12. The signal instructing the X-irradiation is transmitted wirelessly from the imaging control device 12 to the X-ray sources 10a and 10b.

The cable 19 sags loose so as not to be stretched out when the X-ray sources 10a and 10b move to opposing ends of a cross bar or horizontal bar 27 of the holding device 14. Alternatively, the cable 19 may be made from a stretchy material.

Each of the X-ray sources 10a and 10b is provided with an aiming device, for example, a laser light source (not shown) for alignment with the cassette 11 (the subject P). One of the X-ray sources 10a and 10b is arranged at the center of the horizontal bar 27 of the holding device 14. Then, the laser light source applies laser light to the cassette 11. The center of the cassette 11 is aligned with the laser light. Thus, the position of the cassette 11 is calibrated.

The cassette 11 is substantially rectangular in shape. The cassette 11 is connected to the imaging control device 12 via a cable 21. The imaging control device 12 supplies power to the cassette 11. As shown in FIG. 1, the cassette 11 has an image receiving surface 22 facing the X-ray sources 10a and 10b. The cassette 11 is placed under the subject P or a position suitable for an object of interest, for example, under a shoulder or a knee, for example. For the ease of carrying, a handle 23 is provided on a side of the cassette 11. The X-ray sources 10a and 10b are also provided with handles 24a and 24b, respectively. The imaging control device 12 is also provided with a handle (not shown).

The cassette 11 incorporates an X-ray detector 74 (see FIG. 3). The X-ray detector 74 is, for example, a flat panel detector (FPD) having a matrix substrate. The matrix substrate has a plurality of pixels arranged in two-dimensions. Each pixel is composed of a thin film transistor (TFT) and an X-ray detecting element. The X-ray detector 74 accumulates charge, in accordance with an amount of the incident X-ray, in the X-ray detecting element while the TFT is turned off. Then, the TFT is turned on to read out the charge accumulated in the X-ray detecting element. The charge is converted into a voltage signal by an integrating amplifier (not shown) of a signal processor 75 (see FIG. 3). The voltage signal is subjected to A/D conversion in an A/D converter (not shown) of the signal processor 75. Thus, digital image data is generated.

The holding device 14 is connected to the imaging control device 12 via a cable 25. The imaging control device 12 supplies power to the holding device 14. The holding device 14 has a pair of support legs 26 and the cross bar or linear horizontal bar (support member) 27. Each support leg 26 is U-shaped and set up on a floor or ground. Each end of the horizontal bar 27 is connected to a top center of the support leg 26 through a joint 28. Thus, the holding device 14 is assembled. The holding device 14 is symmetric with respect to a center of the horizontal bar 27. Each support leg 26 has a movable joint 29 at its center portion, allowing the support leg 26 to extend or retract to adjust its height.

Hooks (holders) 30a and 30b are attached to the horizontal bar 27. The hook 30a hangs or holds the handle 24a of the X-ray source 10a. The hook 30b hangs or holds the handle 24b of the X-ray source 10b. Thus, the X-ray sources 10a and 10b are attached to the horizontal bar 27 using the hooks 30a and 30b, respectively. The X-ray sources 10a and 10b emit the X-ray in the substantially vertical direction while being hooked.

The hook 30a fits into a groove-like rail or a holder moving section 31a formed on the horizontal bar 27. The rail 31a extends from an end to slightly beyond the center of the horizontal bar 27, parallel to its lengthwise direction. The hook 30a is moved manually along the rail 31a. The hook 30b fits into a groove-like rail or a holder moving section 31b formed on the horizontal bar 27. The rail 31b extends from the other end to slightly beyond the center of the horizontal bar 27, parallel to its lengthwise direction. The hook 31b is moved manually along the rail 31b. The rail 31a is formed on the lower portion of the horizontal bar 27. The rail 31b is formed on the upper portion of the horizontal bar 27. The rails 31a and 31b overlap with each other at the center of the horizontal bar 27. Accordingly, one of the X-ray sources 10a and 10b can be arranged at the center of the horizontal bar 27 while the other X-ray source is positioned at the end of the horizontal bar 27. Thus, an image is captured with the application of the X-ray from the X-ray source arranged at the center of the horizontal bar 27.

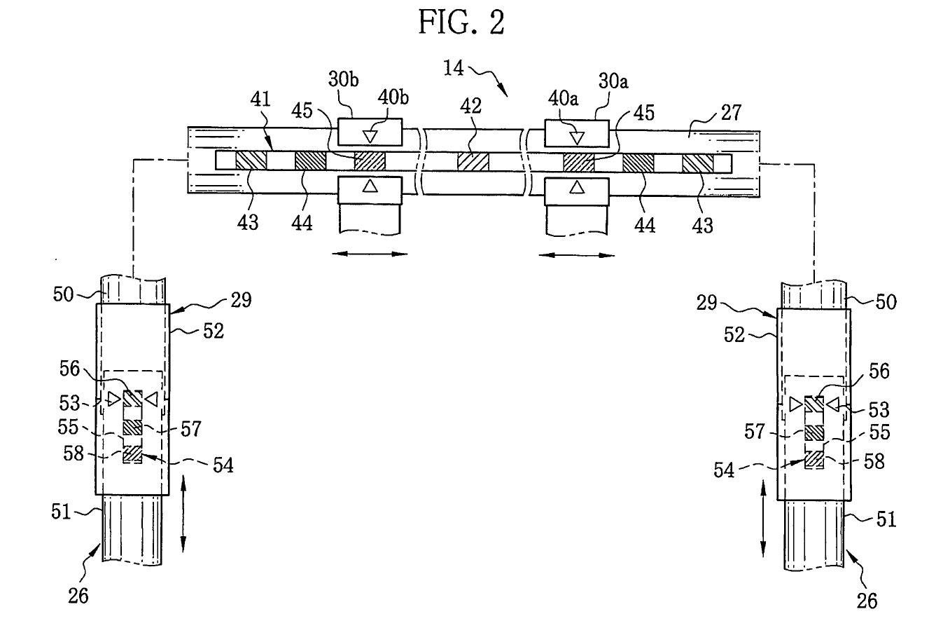

In FIG. 2, each of the hooks 30a and 30b has a C-shape with a back center thereof being cut out (see FIG. 1). A triangular mark 40a is provided at the center of each end of its C-shape of the hook 30a. A triangular mark 40b is provided at the center of each end of its C-shape of the hook 30b. A position indicating section 41 is provided to the horizontal bar 27 in a lengthwise direction. The position indicating section 41 is provided so as to come in contact with or between the ends of the C-shape of the hooks 30a and 30b. The position indicating section 41 has a center lamp 42, a pair of first lamps 43, a pair of second lamps 44, and a pair of third lamps 45. Each of the lamps 42 to 45 is composed of a white LED or an LED of a different color according to its type or category, for example.

The center lamp 42 indicates the center of the horizontal bar 27. The center lamp 42 is turned on to align or position the cassette 11 relative to the X-ray sources 10a and 10b. The third lamps 45, the second lamps 44, and the first lamps 43 are arranged in order of increasing distance from the center of the horizontal bar 27. Each of the pairs of the first lamps 43, the second lamps 44, and the third lamps 45 is symmetric with respect to the center of the horizontal bar 27. The first to third lamps 43 to 45 are selectively turned on in accordance with the object of interest inputted from the input device 15.

The movable joint 29 of the support leg 26 is composed of an upper tube 50, a lower tube 51, and a transparent cover 52 covering the upper and lower tubes 50 and 51. The lower tube 51 is smaller than the upper tube 50 in diameter so as to be fitted into the upper tube 50. The lower tube 51 engages with the upper tube 50 using a known mechanism, for example, a click-stop mechanism. Thereby, the lower tube 51 is slidable to three positions in up-and-down direction along the upper tube 50. When the lower tube 51 is slid upward, the support leg 26 is shortened. Conversely, when the lower tube 51 is slid downward, the support leg 26 is extended.

The upper tube 50 is provided with triangular marks 53 similar to those of the hooks 30a and 30b. The lower tube 51 is provided with a position indicating section 54 similar to the position indicating section 41 of the horizontal bar 27. The marks 53 and the position indicating section 54 are identified visually through the transparent cover 52 and a window or opening 55 formed through the upper tube 50. The position indicating section 54 is provided with a first lamp 45, a second lamp 46, and a third lamp 58 arranged in a vertical or lengthwise direction. First to third lamps 56 to 58 correspond to the first to third lamps 43 to 45, respectively. The first lamp 56 is arranged at the highest position. The third lamp 58 is arranged at the lowest position. The second lamp 57 is arranged between the first and third lamps 56 and 58. Similar to the first to third lamps 43 to 45, the first to third lamps 56 to 58 are selectively turned on in accordance with the object of interest inputted from the input device 15 of the console 13. The marks 53 and the position indicating section 54 are provided to at least one of the movable joints 29. The movable joints 29 are provided to respective support legs 26.

The imaging control device 12 controls each section of the X-ray sources 10a and 10b such that the X-ray from the X-ray source 10a and the X-ray from the X-ray source 10b are applied to the subject P alternately. The X-ray sources 10a and 10b are arranged at two predetermined positions on the horizontal bar 27, respectively, in accordance with the imaging conditions. Upon each application of the X-ray from one of the X-ray sources 10a and 10b, the cassette 11 detects the X-ray passed through the patient P. Thereby, the cassette 11 outputs two image data having parallax.

In FIG. 3, an X-ray source controller 70a of the imaging control device 12 controls overall operation of the X-ray source 10a. The X-ray source controller 70a controls the operation of the X-ray tube 20a, through a driver 71a, according to timing and imaging conditions specified. An X-ray source controller 70b for controlling the X-ray source 10b is configured and operates similar to or the same as the X-ray source controller 70a.

A cassette controller 72 controls overall operation of the cassette 11. The cassette controller 72 controls an operation of the X-ray detector 74, through a driver 73, according to timing and imaging conditions specified. The cassette controller 72 receives image data from the signal processor 75, having the integrating amplifier and the A/D converter, and sends the image data to the console 13.

The console 13 stores the two image data, having parallax, in association with each other in a memory or a storage device. The two image data are outputted from the cassette 11 when the X-ray is applied to the subject P from each of the X-ray sources 10a and 10b arranged at different positions from each other. The two images (two parallax images) are generated based on the two image data, respectively. The console 13 displays the parallax images alternately at regular time intervals on the display 17. Observing the parallax images through a liquid crystal shutter and polarized 3D glasses allows the stereoscopic observation of the X-ray image.

Through a driver 77, a holding device controller 76 controls the operation of the position indicating section 41 of the horizontal bar 27 and the position indicating section 54 of the support leg 26. A memory 78 such as EEPROM is connected to the holding device controller 76. The memory 78 stores a control table 80 shown in FIG. 4. When the object of interest is inputted from the input device 15 of the console 13, the control table 80 is referred to. The control table 80 shows the lamps to be turned on, out of the first to third lamps 43 to 45 on the horizontal bar 27 and the first to third lamps 56 to 58 on the support leg 26, corresponding to the object of interest inputted. In the control table 80, there are three groups or categories of object of interests according to the size of the object of interest or the irradiation area required. For example, the object of interests requiring a large irradiation area includes entire chest. The object of interests requiring a medium-sized irradiation area includes the head. The object of interests requiring a small irradiation area includes a part of the chest. In the control table 80, for the object of interests requiring the large irradiation area, the first lamps 43 and 58 are listed. For the object of interests requiring the medium-sized irradiation area, the second lamps 44 and 59 are listed. For the object of interests requiring the small irradiation area, the third lamps 45 and 60 are listed.

Based on the control table 80 in the memory 78, the holding device controller 76 controls the operations, of the position indicating section 41 on the horizontal bar 27 and the position indicating section 54 on the support leg 26, through the driver 77. To be more specific, when an object of interest requiring the “large” irradiation area is inputted from the input device 15 of the console 13, the first lamps 43 and 58 are turned on. When an object of interest requiring the “medium-sized” irradiation area is inputted, the second lamps 44 and 59 are turned on. When an object of interest requiring the “small” irradiation area is inputted, the third lamps 45 and 60 are turned on. At the same time, the center lamp 42 is turned on. When a signal instructing the X-ray irradiation is inputted from the irradiation switch 16, the holding device controller 76 turns off all the lamps.

The controllers 70a, 70b, 72, and 76 work together to perform stereoscopic imaging for generating the stereoscopic images based on two image data. The two image data are obtained by applications of X-rays from the X-ray sources 10a and 10b arranged at two positions, respectively.

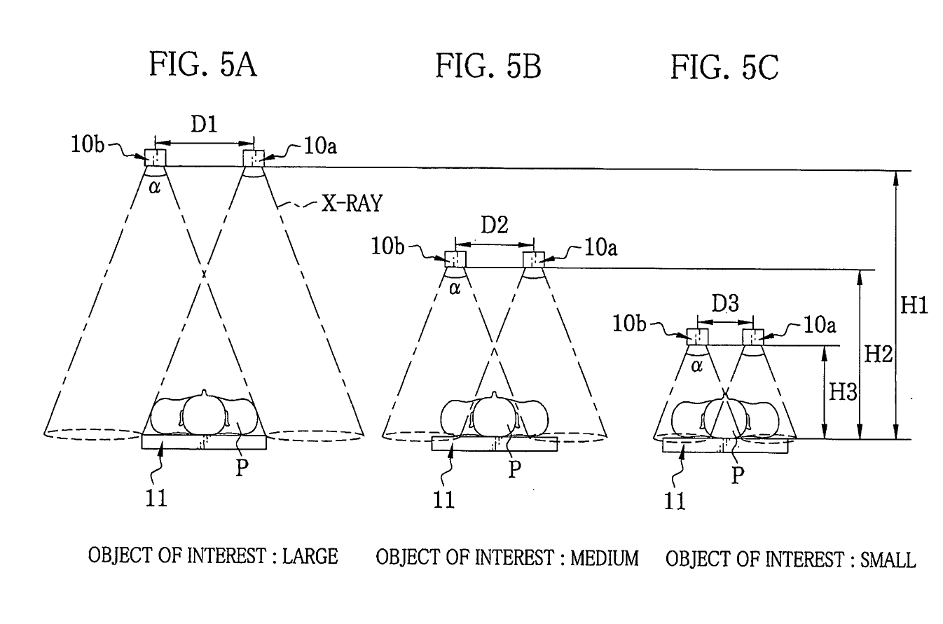

As shown in FIGS. 5A, 5B, and 5C, an overlapping area of the X-ray irradiation becomes the largest when the size of the object of interest (irradiation area) is “large”. The overlapping area of the X-ray irradiation becomes the smallest when the size of the object of interest (irradiation area) is “small”. When the size of the object of interest (irradiation area) is “medium”, the overlapping area of the X-ray irradiation has the size between those of the “large” and “small” object of interests (irradiation areas). Here, D1 denotes a distance, between the X-ray sources 10a and 10b, corresponding to the large object of interest (large irradiation area). D2 denotes a distance, between the X-ray sources 10a and 10b, corresponding to the medium-sized object of interest (medium-sized irradiation area). D3 denotes a distance, between the X-ray sources 10a and 10b, corresponding to the small object of interest (small irradiation area). The distances D1, D2, and D3 decrease with the size of the object of interest (irradiation area). Each of H1, H2, and H3 denotes a distance (hereinafter referred to as SID, abbreviation for source image distance) between the X-ray sources (10a and 10b) and the image receiving surface 22. The H1 is of the large object of interest (large irradiation area). The H2 is of the medium-sized object of interest (medium-sized irradiation area). The H3 is of the small object of interest (small irradiation area). The H1, H2, and H3 also decrease with the size of the object of interest (irradiation area).

The maximum projection angle α, formed by an irradiation opening of the collimator, of each of the X-ray sources 10a and 10b is approximately 12°. To change the X-ray field without changing the size of the irradiation aperture of the collimator, the SID is adjusted by extending or retracting the movable joint 29 of each of the support legs 26. In accordance with the SID, the distance between the X-ray sources 10a and 10b is adjusted by moving the hook 30a along the rail 31a and the hook 30b along the rail 31b. In other words, the distance between the X-ray sources 10a and 10b is determined by the size of the X-ray irradiation area corresponding to the object of interest, the maximum projection angle α, and the SID. The maximum projection angle refers to an angle between two equal sides of an isosceles triangle having a focal point of the X-ray tube 20a or 20b as an apex and a line between the ends of the irradiation aperture as the base.

Each of the first lamps 43 of the position indicating section 41 on the horizontal bar 27 is located at a distance (D1)/2 away from the center of the horizontal bar 27. Each of the second lamps 44 is located at a distance (D2)/2 away from the center of the horizontal bar 27. Each of the third lamps 45 is located at a distance (D3)/2 away from the center of the horizontal bar 27. The first lamp 56 of the position indicating section 54 on the support leg 26 is located at a position where the SID is “H1”. The second lamp 57 is located at a position where the SID is “H2”. The third lamp 58 is located at a position where the SID is “H3”. It should be noted that the size of the irradiation area for the object of interest is previously determined based on a person with a body width larger than the standard figure.

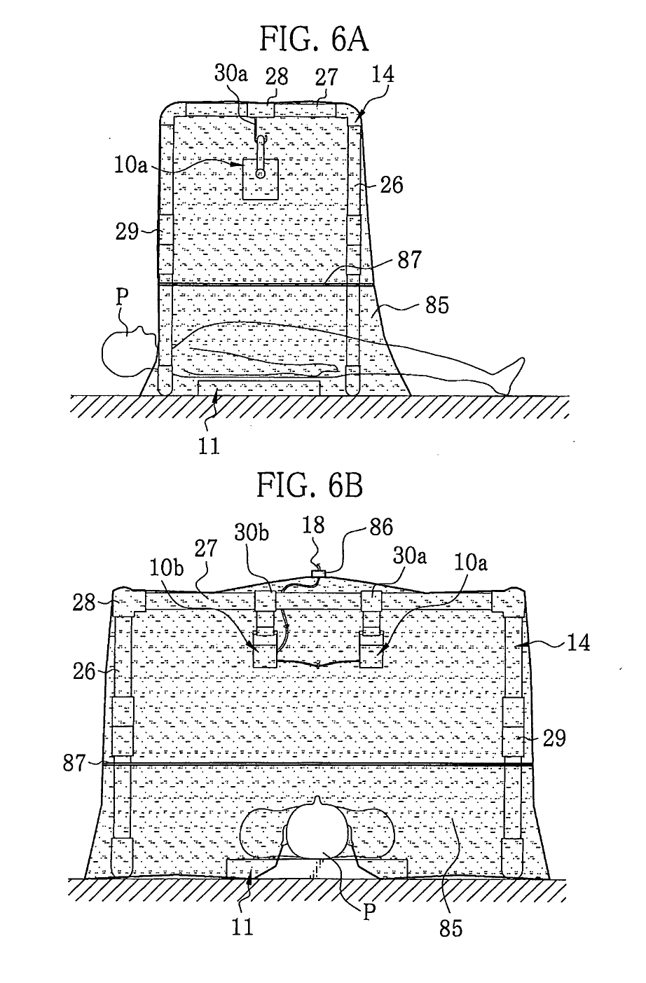

As shown in FIGS. 6A and 6B, the X-ray imaging system 2 in use is covered with an X-ray shielding sheet 85 to reduce the risk of unnecessary X-ray exposure near the X-ray imaging system 2.

The X-ray shielding sheet 85 is made of a flexible sheet-like material containing a substance with high X-ray shielding effect such as lead. The X-ray shielding sheet 85 has the size enough to cover substantially the entire X-ray imaging system 2. The X-ray shielding sheet 85 is attached to the joint 28 and the horizontal bar 27, for example. The X-ray shielding sheet 85 hangs down to the ground to completely cover the entire X-ray imaging system 2 including the object of interest of the subject P.

A cable fixer 86 is provided on a top end of the X-ray shielding sheet 85. The cable fixer 86 fixes approximately the middle of the cable 18 that connects the imaging control device 12 to the X-ray source 10b. The cable 18, sagging between the cable fixer 86 and the X-ray source 10b, is housed in the X-ray shielding sheet 85. The cable sags loose so as not to be stretched out when the hook 30b moves along the rail 31b from the center to the left end of the horizontal bar 27. From the cable fixer 86, the cable 18 is extended or retracted along with the movement of the hook 30b.

On the subject P side of a space covered by the X-ray shielding sheet 85, a simple irradiation area limiting sheet 87 is attached to cover the entire subject P. Similar to the X-ray shielding sheet 85, the simple irradiation area limiting sheet 87 has flexibility and contains a substance with high X-ray shielding effect such as lead. The simple irradiation area limiting sheet 87 is set up inside the space covered by the X-ray shielding sheet 85 substantially parallel to the image receiving surface 22.

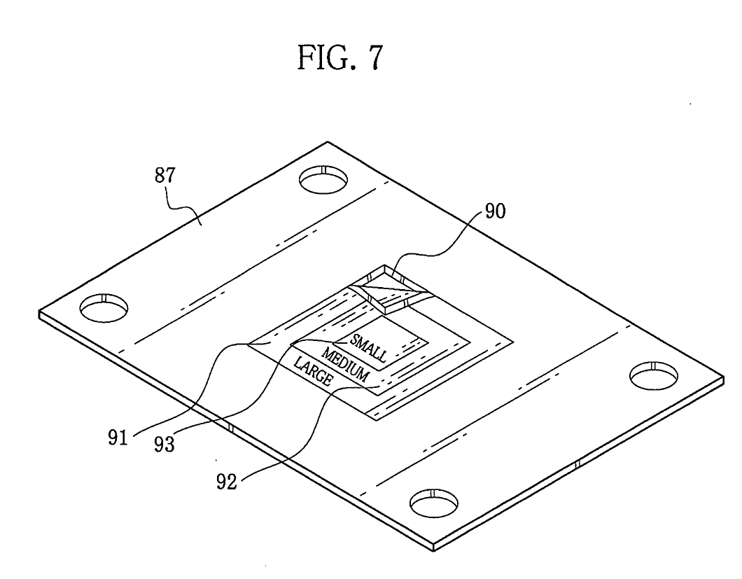

As shown in FIG. 7, an opening 90 is provided at the center of the simple irradiation area limiting sheet 87. The size of the opening 90 corresponds to the size of the object of interest (the size of the irradiation area) and varies according to the sizes of removable sheets 91, 92, and 93, for example. The opening 90 is completely covered with the removable sheets 91, 92, and 93. The sheet 91 is removable from the simple irradiation area limiting sheet 87. The sheet 92 is removable from the sheet 91. The sheet 93 is removable from the sheet 92. The sheet 91 has the size to make the irradiation area suitable for the “large” object of interest. Namely, when the sheet 91 is removed, the opening 90 with the size of the sheet 91 is formed. This opening 90 allows to form the irradiation area suitable for the large object of interest. The remaining sheet 87 blocks or eliminates the X-ray (shown by ovals depicted with broken lines in FIG. 5A) outside the suitable irradiation area. The sheet 92 has the size to make the irradiation area suitable for the “medium-sized” object of interest. Namely, when the sheet 92 is removed, the opening 90 with the size of the sheet 92 is formed. This opening allows to form the irradiation area suitable for the medium-sized object of interest. The remaining sheets 87 and 91 block or eliminate the X-ray (shown by ovals depicted with broken lines in FIG. 5B) outside the suitable irradiation area. The sheet 93 has the size to make the irradiation area suitable for the “small” object of interest. Namely, when the sheet 93 is removed, the opening 90 with the size of the sheet 93 is formed. This opening 90 allows to form the irradiation area suitable for the small object of interest. The remaining sheets 87, 91, and 92 block or eliminate the X-ray (shown by ovals depicted with broken lines in FIG. 5C) outside the suitable irradiation area. For attaching the X-ray shielding sheet 85 to the holding device 14, and for attaching the simple irradiation area limiting sheet 87 to the X-ray shielding sheet 85, and for attaching the sheets 91 to 93 to the simple irradiation area limiting sheet 87, hooks, snaps, hook-and-loop fasters, magic tapes (registered trademark), or screws may be used, for example.

Next, an operation of the above configuration is described. The X-ray imaging system 2 is carried or transported to an on-site location. The holding device 14 is assembled as shown in FIG. 1. The X-ray sources 10a and 10b are hooked onto the hooks 30a and 30b, respectively. The cable 18 is connected to the X-ray source 10b. The cable 19 is connected between the X-ray sources 10a and 10b. The cable 21 is connected to the cassette 11. The cable 25 is connected to the holding device 14. Thus, the imaging control device 12 is connected to each of the X-ray sources 10a and 10b, the cassette 11, and the holding device 14.

When the X-ray imaging system 2 is set up, an object of interest, imaging conditions, and the like are inputted from the input device 15 of the console 13. The holding device controller 76 turns on the center lamp 42. The control table 80 in the memory 78 is referred to, and a line of the control table 80 corresponding to the object of interest is read out. Out of the first to third lamps 43 to 45 of the position indicating section 41 and the first to third lamps 56 to 58 of the position indicating section 54, the lamps indicating the SID and the positions of the X-ray sources 10a and 10b, suitable for the object of interest, are turned on.

One of the X-ray sources 10a and 10b is moved to coincide with the center lamp 42, and thus positioned at the center of the horizontal bar 27. Light is projected to the cassette 11 from an aiming device, for example, a laser light source. The position of the cassette 11 is adjusted such that the light from the aiming device coincides with the center of the light receiving surface 22. Thus, the relative position between the cassette 11 and the holding device 14 is adjusted.

To adjust the SID, the support leg 26 is extended or shortened through the movable joint 29 such that the marks 53 of the upper tube 50 coincides with the lamp 56, 57, or 58 turned on. To arrange the X-ray source 10a at the position corresponding to the object of interest, the hook 30a is moved along the rail 31a such that the marks 40a of the hook 30a coincide with the lamp 43, 44, or 45 turned on. To arrange the X-ray source 10b at the position corresponding to the object of interest, the hook 30b is moved along the rail 31b such that the marks 40b of the hook 30b coincide with the lamp 43, 44, or 45 turned on.

After the SID and the positions of the X-ray sources 10a and 10b are adjusted, the subject P is laid in a face-up position. The X-ray shielding sheet 85 with the simple irradiation area limiting sheet 87 is attached to the holding device 14 to cover the object of interest and the entire X-ray imaging system 2. The middle of the cable 18 is fixed by the cable fixer 86. The middle of the cable 18 and the cable 18 sagging from the cable fixer 86 are housed in the X-ray shielding sheet 85. Out of the removable sheets 91 to 93 of the simple irradiation area limiting sheet 87, the sheet corresponding to the object of interest is removed to open the opening 90 with the size suitable for the object of interest.

The irradiation switch 16 connected to the imaging control device 12 is pushed to instruct the start the irradiation. In response to this, the holding device controller 76 turns off the lamps. X-ray is applied to the subject P from the X-ray tube 20a of the X-ray source 10a and the X-ray tube 20b of the X-ray source 10b sequentially. The X-ray detector 74 of the cassette 11 detects the X-ray passed through the subject P.

The console 13 stores the two image data in association with each other. The stereoscopic X-ray images are formed based on the two image data and displayed on the display 17. A doctor observes the image and makes a diagnosis. The doctor may send the image data to distant medical facilities through a network to seek advice from a specialist.

As described above, according to the invention, the lamps corresponding to the object of interest are turned on to indicate the appropriate height of the support legs 26 and the appropriate positions of the X-ray sources 10a and 10b. Then, the height and the positions are adjusted according to the lamps. Thus, the X-ray imaging system is set up easily, avoiding incorrect height and/or positions resulting in imaging failure. As a result, the imaging time is shortened.

In emergency medical care, the X-ray imaging may be necessary for a patient, being immobile due to pain or the like. A home care patient, for example, an elderly bedridden patient has difficulty in keeping the same posture. The portable radiation imaging system 2 is especially invaluable for such patients because the portable radiation imaging system 2 is transported to the emergency scene or the patient's house and the images are captured promptly in the reduced imaging time.

The X-ray tubes 20a and 20b are compact and lightweight. Accordingly, burden in transportation and assembly is reduced, and thereby parts of the holding device 14 require less strength. As a result, the holding device 14 becomes compact and lightweight.

The object of interest and the X-ray imaging system 2 are covered with the X-ray shielding sheet 85. The X-ray shielding sheet 85 prevents leakage of X-ray outside and precludes people nearby from being exposed to the X-ray. Body parts other than the object of interest, for example, the head or legs uncovered with the X-ray shielding sheet 85 can reduce the risk of unnecessary X-ray exposure. Thus, the X-ray imaging is performed safely even if there are many people around the subject P.

The X-ray shielding sheet 85 and the simple irradiation area limiting sheet 87 are flexible and folded or rolled when not in use. For example, the horizontal bar 27 may be made hollow to accommodate the X-ray shielding sheet 85 and the simple irradiation area limiting sheet 87.

The middle of the cable 18, being fixed by the cable fixer 86, and the cable 18 sagging from the cable fixer 86 are housed in the X-ray shielding sheet 85. Thus, the cable 18 is stored compactly. This prevents accidents such as stumbling over or pulling out the cable 18, which interrupts the imaging process. A sagging part of the cable 21 connecting the cassette 11 and the imaging control device 12 and a sagging part of the cable 25 connecting the holding device 14 and the imaging control device 12 may also be housed in the X-ray shielding sheet 85 similar to that of the cable 18.

Each cable may be provided with a cable spool to prevent accidents caused by the cable and to improve compactness of storage and portability. The cable is wound onto the cable spool when not in use and unwound when in use. The cable spool may be provided to the support leg 26. Alternatively, the cable spool maybe provided to the imaging control device 12, namely, the cable is wound in the imaging control device 12 and stored.

The irradiation area for the object of interest is limited by the simple irradiation area limiting sheet 87. Thus, it is unnecessary to change the size of the irradiation aperture of the collimator. This permits the use of an X-ray source with no collimator.

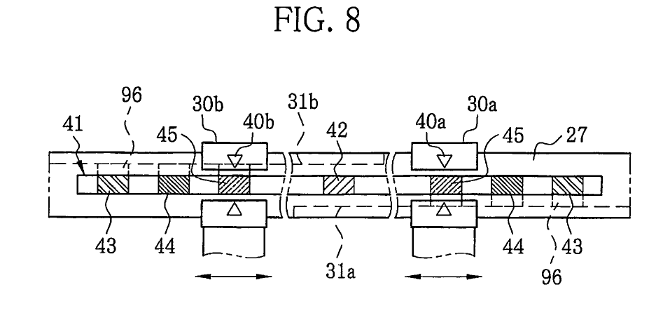

The positions of the hooks 30a and 30b on the horizontal bar 27 may be detected. An error may be displayed when the hook 30a or 30b is shifted from the correct position corresponding to the object of interest. To be more specific, an alarm section is provided to the holding device 14. The alarm section includes, for example, an alarm lamp 95 (see FIG. 1) for indicating an error. As shown in FIG. 8, on each of the rails 31a and 31b, photosensors 96 are provided at the same positions as those of the lamps, respectively. Each photosensor 96 is composed of a light projector and a light receiver (both not shown). When the hook 30a or 30b is moved to the position of the photosensor 96, the light from the light projector is reflected by the hook 30a or 30b, and then incident on and detected by the light receiver. Conversely, when the hook 30a or 30b is not positioned on the photosensor 96, the light from the light projector is scattered and not detected by the light receiver.

When the irradiation switch 16 is operated to instruct the start of the X-ray irradiation, the imaging control device 12 activates the photosensor 96, located in the same position as that of the lamp, corresponding to the object of interest. When there is no response from the photosensor 96, namely, when the light receiver does not detect the light from the light projector, the imaging control device 12 does not start the X-ray irradiation. Instead, the imaging control device 12 turns on the alarm lamp 95 to notify that the position of the X-ray source is incorrect. Alternatively, the photosensor 96 may be activated when the object of interest is inputted. The alarm lamp 95 may be kept turned on until the photosensor 96 responds. This prevents imaging failure beforehand, resulting in reduced imaging time.

When one of the X-ray sources 10a and 10b is in an incorrect position, an alarm may be displayed after the imaging is performed using the other X-ray source in the correct position. The photosensors 96 may be arranged at regular intervals on each of the rails 31a and 31b. This permits detection of the positions of the hooks 30a and 30b regardless of the positions of the lamps. A microswitch may be used as a position detector instead of the photosensor.

The number of X-ray sources is not limited to two. It is possible to use only one X-ray source. In this case, the X-ray source is positioned in the first of the two positions on the horizontal bar 27 to capture the first image. Then, the X-ray source is moved to the second position to capture the second image. In the above embodiment, the lamps are turned off when the X-ray irradiation is instructed. In the configuration using the single X-ray source, on the other hand, the lamps are turned on again, before the second image capture, to indicate the appropriate position of the X-ray source. In the configuration using the single X-ray source, moving the X-ray source to the second position is an extra step, which is unnecessary in the configuration using the two X-ray sources. However, the configuration using the two X-ray sources has less mobility and is more expensive than that using the single X-ray source. It is preferable to determine the number of X-ray sources as necessary.

In the above embodiment, there are three kinds of groups or categories (large, medium-sized, and small) for the object of interests according to its size by way of example. Alternatively, two or more than three categories may be provided. When there are three or more categories, the lamps of each category are made distinguishable from those of other categories. The removable sheets of the simple irradiation area limiting sheet 87 are also provided according to the number of categories.

The subject P may be rotated 90° about his/her body axis from the posture in the above embodiment, namely, the subject P may be in a side-lying position. Similar to the above embodiment, the SID, the distance between the X-ray sources 10a and 10b and the like may be predetermined according to an object of interest. Alternatively, the subject may be in a standing position. In this case, the cassette 11 has its image receiving surface 22 vertical to the horizontal plane. The SID adjustment mechanism of the support legs is configured to be adjusted horizontally. Thus, the present invention is applicable.

A message (“align the marks of the support legs and the X-ray sources with their respective first lamps”, for example) describing the positions indicated by the position indicating sections 41 and 54 may be displayed on the display 17 of the console 13. In this case, the console 13 receives information of the control table 80 from the imaging control device 12 after the object of interest is inputted, and displays the message on the display 17 in a pop-up window or the like. Thereby, the positions corresponding to the object of interest are displayed before the assembly of the system, which facilitates the setup. This also works as a backup when the lamps of the position indicating sections 41 and 54 fail.

The position indicating section for indicating the positions of the X-ray sources 10a and 10b may be simply marks, for example, triangular marks, for pointing a correct position. In this case, the name of the category indicating the size of the object of interest or the irradiation area, or a sign representing the category (for example, letters “large”, “medium”, or “small” in the above embodiment) is printed with the corresponding mark. This makes the holding device 14 more compact and lightweight than that using the lamps.

The present invention may be applied to a system with a driving force for automatically moving the X-ray source. The driving force is composed of, for example, a stepping motor or the like driven responsive to an instruction from the imaging control device 12. The driving force moves the hook 30a together with the X-ray source 10a hanging from the hook 30a along the rail 31a, and the hook 30b together with the X-ray source 10b hanging from the hook 30a along the rail 31a. When the driving force stops, the X-ray sources 10a and 10b stop at their respective predetermined positions on the horizontal bar 27.

The imaging control device 12 counts driving voltage pulses in the driving force (pulses applied to the stepping motor). Thereby, the imaging control device 12 detects the positions of the X-ray sources 10a and 10b on the horizontal bar 27 based on the counts to move the X-ray sources 10a and 10b to the positions suitable for the object of interest. As described with reference to the FIGS. 5A, 5B, and 5C, a distance between the X-ray sources 10a and 10b is determined based on the size of irradiation area corresponding to the object of interest, the maximum projection angle α, and the SID. Accordingly, the distance between the X-ray sources 10a and 10b can be determined in advance. The imaging control device 12 may store the distance between the X-ray sources 10a and 10b in association with the object of interest. When the driving force is controlled based on the distance, stored in the imaging control device 12, to move the X-ray sources 10a and 10b to their respective positions suitable for the object of interest, manual adjustment is unnecessary. In this case, the position indicating section 41 is not activated, and used as a backup when the driving force fails.

The support legs 26 may be extended or retracted automatically. Each movable joint 29 may be composed of an actuator such as a hydraulic damper. In addition, a sensor for detecting amounts of extension and retraction of the support leg may be provided. The actuator is driven based on the detection result of the sensor to automatically control the amounts of extension and retraction of the support leg, namely, the SID. In this case, the position indicating section 54 is used as a backup when the actuator and/or the sensor fails.

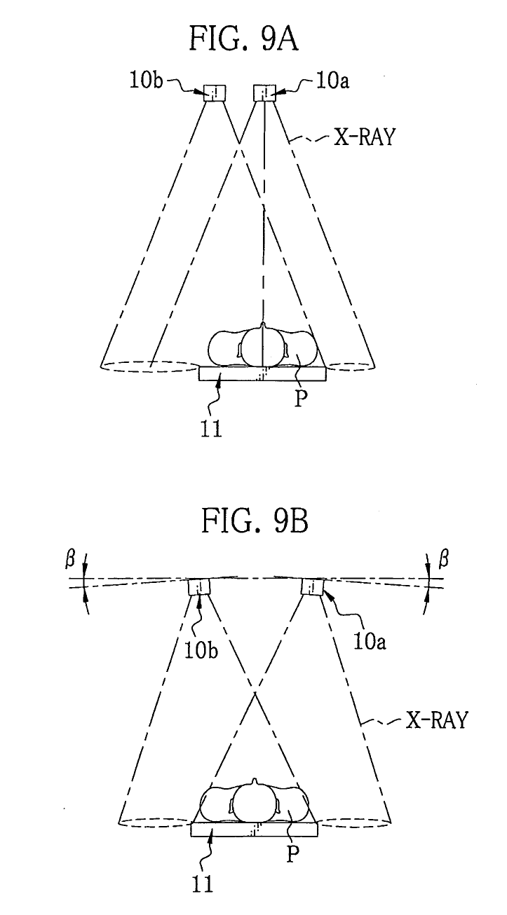

In the above embodiment, the X-ray sources 10a and 10b are arranged at two positions, respectively, symmetric with respect to the center of the horizontal bar 27 by way of example. The present invention is not limited to the above. Each of the X-ray sources 10a and 10b may be arranged at any position where parallax is caused. For example, as shown in FIG. 9A, the X-ray source 10a may be arranged at the center of the horizontal bar 27, and the X-ray source 10b may be arranged at the position shifted from the center to perform the stereoscopic imaging. Alternatively, as shown in FIG. 9B, the hooks 30a and 30b may be provided with a swing mechanism for changing directions of the X-ray sources 10a and 10b. Each of the X-ray sources 10a and 10b may be tilted at an angle β relative to the cassette 11. In this case, a distance between the X-ray sources 10a and 10b is determined based on the angle β of the X-ray sources 10a and 10b in addition to the size of the X-ray irradiation area corresponding to the object of interest, the maximum projection angle α, and the SID. The tilt angle β shortens the SID compared to that in the above embodiment, and thus reduces the size of the holding device 14. Additionally, a position indicating section for indicating a tilt angle corresponding to the object of interest may be provided.

In the above embodiment, the X-ray sources 10a and 10b are moved along the rails 31a and 31b on the linear horizontal bar 27, respectively. Alternatively, a cross bar in arc shape may be used to move each of the X-ray sources 10a and 10b on a curved trajectory. In this case, the X-ray sources 10a and 10b face the cassette 11 naturally and thus the swing mechanism is unnecessary.

Each of the positions indicated by the position indicating sections 41 and 54 may be within an allowable range in which the stereoscopic observation is possible. In this case, the X-ray source may be shifted from the exact position as long as the X-ray source is within the allowable range. This permits fine adjustments of the positions of the X-ray sources 10a and 10b.

The imaging system according to the present invention can take various configurations within the scope of the invention. In the above embodiment, the X-ray detector 74 is operated responsive to the instruction from the imaging control device 12 by way of example. Alternatively, the X-ray detector 74 itself may detect the X-ray irradiation and operate responsive to the detection without the instruction from the imaging control device 12.

The X-ray detector 74 is not limited to a direct conversion type as described in the above embodiment. Alternatively, an indirect conversion type X-ray detector may be used. In this case, the incident X-ray is converted into visible light using a scintillator, and then the visible light is converted into an electrical signal using a solid-state detector such as amorphous silicon (a-Si).

The cassette 11 is connected to the imaging control device 12 via the cable 21. The holding device 14 is connected to the imaging control device 12 via the cable 25. Alternatively, the cassette 11, the holding device 14, and the imaging control device 12 maybe connected wirelessly. In this case, each of the cassette 11 and the holding device 14 is loaded with a battery for power supply.

The functions of the controllers 72 and 76 and the drivers 73 and 77 may not be provided to the imaging control device 12. Alternatively, the above functions may be provided to the cassette 11 and/or the holding device 14. The drivers 71a and 71b, being the high voltage generators, may be provided separately from the imaging control device 12.

The support legs 26 and the horizontal bar 27 may be integrated using a folding joint. The X-ray shielding sheet 85 may not be large enough to cover the entire system of the above embodiment. The X-ray shielding sheet 85 may have the size to cover at least the sagging cable 18. The simple irradiation area limiting sheet 87 may not be attached to the X-ray shielding sheet 85. The X-ray shielding sheet 85 and the simple irradiation area limiting sheet 87 may be used separately.

In the above embodiment, the present invention is applied to the stereoscopic imaging by way of example. The present invention may be applied to tomosynthesis imaging. In the tomosynthesis imaging, X-ray is applied to a subject from different angles while an X-ray source is moved. The images captured are added to obtain a tomographic image in which a region of interest (ROI) of the subject P is emphasized.

The present invention is not limited to the X-ray imaging system. The present invention is also applicable to an imaging system using radiation other than the X-ray, for example, gamma ray.

Various changes and modifications are possible in the present invention and may be understood to be within the present invention.

What is claimed is:

1. A holding device for use in a portable radiation imaging system comprising:
a set of support legs for adjusting a distance between at least one radiation source and an image receiving surface of a radiation image detector in accordance with a size of an irradiation area of radiation, the radiation source applying the radiation to a subject, the radiation image detector receiving the radiation passed through the subject to detect an image;
a support member joined between the set of support legs;
holders each designed to hold the radiation source and provided in respective positions on the support member, the at least two holders being used for arranging the at least one radiation source, the radiation source applying the radiation to the subject while being held by the holder; and
a first indicating section provided to the support member, the first indicating section indicating the positions of the radiation source to be arranged, the positions being distinguishable in accordance with the size of the irradiation area.

2. The holding device of claim 1, wherein the support member is provided with a holder moving section for supporting the holders in a movable manner.

3. The holding device of claim 2, wherein the support leg is provided with a second indicating section for indicating distance positions for adjusting the distance, the distance positions being distinguishable in accordance with the size of the irradiation area.

4. The holding device of claim 3, wherein at least one of the first indicating section and the second indicating section has lamps or marks arranged at the respective positions or the distance positions.

5. The holding device of claim 2, further including:
a position detecting sensor for detecting the position of the holder; and
an alarm section for giving an alarm signal when a detection result of the position detecting sensor is different from the position corresponding to the size of the irradiation area.

6. The holding device of claim 5, wherein the alarm section gives the alarm signal before irradiation of the radiation when the holder is not positioned at a position appropriate for applying the radiation.

7. The holding device of claim 1, further including an irradiation area limiting sheet disposed between the radiation source and the radiation image detector, the irradiation area limiting sheet limiting the irradiation area of the radiation applied to the subject.

8. The holding device of claim 7, wherein the irradiation area limiting sheet is composed of a radiation shielding sheet, an opening formed on the radiation shielding sheet for allowing radiation, having an amount corresponding to the irradiation area, to pass through, and a removable sheet for covering or uncovering the opening.

9. The holding device of claim 1, further including a driving force for moving the holders to the positions corresponding to the size of the irradiation area.

10. A portable radiation imaging system comprising:
(A) at least one radiation source for applying radiation to a subject;
(B) a radiation image detector for receiving the radiation passed through the subject to detect an image;
(C) a holding device including:
a set of support legs for adjusting a distance between the radiation source and an image receiving surface of the radiation image detector in accordance with a size of an irradiation area of the radiation;
a support member joined between the set of support legs;
holders each designed to hold the radiation source and provided in respective positions on the support member, the at least two holders being used for arranging the at least one radiation source, the radiation source applying the radiation to the subject while being held by the holder; and
an indicating section provided to the support member, the indicating section indicating the positions of the radiation source to be arranged, the positions being distinguishable in accordance with the size of the irradiation area; and
(D) an image processing device for processing image data outputted from the radiation image detector.

11. The portable radiation imaging system of claim 10, wherein the at least two image data are generated to perform stereoscopic imaging that allows stereoscopic observation.

12. The portable radiation imaging system of claim 10, wherein the system performs tomosynthesis imaging in which the at least two image data are added to obtain a tomographic image emphasizing a region of interest of the subject.

13. The portable radiation imaging system of claim 10, wherein the image processing device displays the positions corresponding to the irradiation area, out of all the positions for the radiation source, on a display.

14. A portable radiation imaging apparatus comprising:
(A) a radiation image detector for receiving radiation passed through a subject to detect an image;
(B) a holding device including:
a set of support legs for adjusting a distance between at least one radiation source and an image receiving surface of the radiation image detector in accordance with a size of irradiation area of the radiation, the radiation source applying radiation to the subject;
a support member joined between the set of support legs;
holders each designed to hold the radiation source and provided in respective positions on the support member, the at least two holders being used for arranging the at least one radiation source, the radiation source applying the radiation to the subject while being held by the holder; and
an indicating section provided to the support member, the indicating section indicating the positions of the radiation source to be arranged, the positions being distinguishable in accordance with the size of the irradiation area; and
(C) an image processing device for processing image data outputted from the radiation image detector.
